(19) United States
(12) Patent Application Publication
(10) Pub. No.: US 2025/0208316 A1
(43) Pub. Date: Jun. 26, 2025

(54) COMPOSITION FOR CAMERA MODULE LENS AND CAMERA MODULE LENS COMPRISING THE SAME

(71) Applicant: Samsung Electro-Mechanics Co., Ltd., Suwon-si (KR)

(72) Inventors: Seong Chan PARK, Suwon-si (KR); Min Ji KIM, Suwon-si (KR); Sang Hyun KWON, Suwon-si (KR); Sang Yun YANG, Suwon-si (KR)

(73) Assignee: Samsung Electro-Mechanics Co., Ltd., Suwon-si (KR)

(21) Appl. No.: 18/925,930

(22) Filed: Oct. 24, 2024

(30) Foreign Application Priority Data
Dec. 22, 2023 (KR) 10-2023-0190388

(51) Int. Cl. G02B 1/04; G02B 5/22; G03B 11/00; G03B 30/00

(52) U.S. Cl. CPC G02B 1/041; G02B 5/223; G03B 11/00; G03B 30/00

(57) ABSTRACT

A composition for a camera module lens includes a resin; an ultraviolet (UV) absorbing dye; and a near infrared ray (NIR) absorbing dye. The UV-absorbing dye and the NIR-absorbing dye are adsorbed or dispersed between polymer chains of the resin.

### CROSS-REFERENCE TO RELATED APPLICATIONS

This application claims the benefit under 35 USC 119(a) of Korean Patent Application No. 10-2023-0190388 filed on Dec. 22, 2023, in the Korean Intellectual Property Office, the entire disclosure of which is incorporated herein by reference for all purposes.

### BACKGROUND

### 1. Field

The present disclosure relates to a composition for a camera module lens and a camera module lens including the same.

### 2. Description of the Background

Camera modules include a lens, a driving body, an image sensor, and an IR filter.

The IR filter serves to allow light in the range of 400 to 700 nm, which is a range of light that the human eye may generally see, to pass therethrough and cut off light in an ultraviolet (UV) or near infrared ray (NIR) wavelength range.

Since the image sensor also detects light in the wavelength range of 700 to 1000 nm, a reddish screen appears when an image is captured, and the IR filter serves to filter out such near-infrared wavelengths.

Some lenses may absorb UV and NIR regions instead of IR filters, and others may cut off UV and NIR by applying an absorbing dye to a plastic lens or forming a coating layer through a deposition method.

In the case of a lens that may play the role of a cutoff of the related art IR filter, a special dye capable of absorbing light in the UV wavelength range and NIR wavelength range may be desired.

However, when UV-absorbing dyes or NIR-absorbing dyes that are generally applied to display coatings are applied to plastic lenses, the miscibility between a dye and a resin may not be good. Since lenses are typically manufactured by injection-molding a resin at high temperature, there is a problem in that a UV absorption function and an NIR absorption function are lost due to a thermal decomposition of the dye during injection-molding.

For this reason, it may be desirable to develop a dye suitable for a material when manufacturing lenses, and at the same time, a technology that may prevent the decomposition of the dye during high-temperature injection molding.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a composition for a camera module lens includes a resin; an ultraviolet (UV) absorbing dye; and a near infrared ray (NIR) absorbing dye. The UV-absorbing dye and the NIR-absorbing dye are adsorbed or dispersed between polymer chains of the resin.

The UV-absorbing dye may include an amount of 0.002 to 0.1 wt % based on a total weight of the composition.

The NIR-absorbing dye may include an amount of 0.002 to 0.1 wt % based on a total weight of the composition.

The resin may be cyclo-olefin copolymer (COC). The UV-absorbing dye may be a methine series. The NIR-absorbing dye may be a squaraine series.

The composition may include 0.002 to 0.1 wt % of a UV-absorbing dye of the methine series and 0.002 to 0.1 wt % of a NIR-absorbing dye of the squaraine series based on a total weight of the composition. The composition may have an absorption range of 400 to 430 nm and another absorption range of 700 nm or more. The composition may have a light transmittance of 20 to 60% at 400 to 430 nm and a light transmittance of 10 to 50% at 700 nm.

The resin may be cyclo-olefin polymer (COP). The UV-absorbing dye may be any one or any combination of any two or more of pyrimidine, pyrazole and methine series. The NIR-absorbing dye may be a squaraine series.

The composition may include 0.002 to 0.1 wt % of a UV-absorbing dye of any one or any combination of any two or more of pyrimidine, pyrazole and methine series, and 0.002 to 0.1 wt % of a NIR-absorbing dye of squaraine series based on a total weight of the composition. The composition may have an absorption range of 400 to 430 nm and another absorption range of 700 nm or more. The composition may have a light transmittance of 20 to 60% at 400 to 430 nm and a light transmittance of 10 to 50% at 700 nm.

The NIR-absorbing dye may have a molecular weight of 700 or more.

The NIR-absorbing dye may have a squaraine series having a chemical structure of:

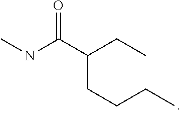

The resin may be polycarbonate (PC). The UV-absorbing dye may be any one or any combination of any two or more of the pyrimidine, pyrazole and methine series. The NIR-absorbing dye may be the squaraine series.

The composition may include 0.002 to 0.1 wt % of a UV-absorbing dye of any one or any combination of any two or more of pyrimidine, pyrazole and methine series, and 0.002 to 0.1 wt % of a NIR-absorbing dye of squaraine series based on a total weight of the composition. The composition may have an absorption range of 400 to 430 nm and another absorption range of 700 nm or more. The composition may have a light transmittance of 20 to 60% at 400 to 430 nm and a light transmittance of 10 to 50% at 700 nm.

The NIR-absorbing dye may have a molecular weight of 700 or more.

The NIR-absorbing dye may be a squaraine series having a chemical structure of:

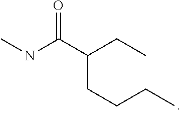

A camera module lens includes a plurality of lenses, wherein one or more lenses of the plurality of lenses may include the any of the compositions described herein.

Other features and aspects will be apparent from the following detailed description, the drawings, and the claims.

### BRIEF DESCRIPTION OF DRAWINGS

FIG. 1 is a cross-sectional view schematically illustrating a camera module according to an embodiment in the present disclosure.

FIG. 2 is an enlarged view of portion A of the lens of FIG. 1.

FIG. 3 is a graph illustrating light transmittance of a camera module lens according to an embodiment in the present disclosure.

FIG. 4 is a graph illustrating results of UV-VIS analysis of a UV-absorbing dye of the methine series.

FIG. 5 is a graph illustrating results of UV-VIS analysis of a first NIR-absorbing dye.

FIG. 6 is a graph illustrating results of UV-VIS analysis of a pyrazole series UV-absorbing dye.

FIG. 7 is a graph illustrating results of UV-VIS analysis of a pyrimidine series UV-absorbing dye.

FIG. 8 is a graph illustrating results of UV-VIS analysis of a second NIR-absorbing dye.

FIG. 9 is a graph illustrating light transmittance of a lens formed only of the related art resin.

FIG. 10 is a graph illustrating light transmittance of a lens formed of a composition according to a first example of the present disclosure.

FIG. 11 is a graph illustrating a change in light transmittance according to an injection-molding temperature of a lens formed of a composition according to the first example of the present disclosure.

FIG. 12 is a graph illustrating a comparison between light transmittance of a lens formed of a composition according to a second example of the present disclosure and light transmittance of a lens of a comparative example, each injection-molded at 300° C.

FIG. 13 and FIG. 14 are graphs illustrating a comparison in light transmittance of a lens according to a UV-absorbing dye in the second example of the present disclosure.

FIG. 15 illustrates light transmittance of a lens manufactured using PC as a resin in the second example of the present disclosure.

FIG. 16 is a graph illustrating results of a high-temperature and high-humidity reliability test of a lens according to an embodiment in the present disclosure.

FIG. 17 is a graph illustrating results of a thermal shock reliability test of a lens according to an embodiment in the present disclosure.

FIG. 18 and FIG. 19 are photographs illustrating chromatic aberrations of the related art lens and a lens manufactured through an embodiment in the present disclosure.

FIGS. 20 and 21 are photographs for comparing the flare of the related art lens and a lens manufactured through an embodiment in the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein.

However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

### Composition for Camera Module Lens

A composition for A camera module lens of the present disclosure includes a resin, an ultraviolet (UV) absorbing dye, and a near-infrared ray (NIR) absorbing dye.

In addition, the UV-absorbing dye and the NIR-absorbing dye are adsorbed or dispersed between polymer chains of the resin by the TT-TT interaction or the van der Waals bond. When unit molecules of the dye are dispersed between the polymer chains of the resin or when the polarity of the dye is similar to that of the resin, the unit molecules of the dye and the polymer of the resin may be adsorbed to each other.

Here, the resin and the dye may be mixed by compounding or injection mixing. Still, there is a problem in that the dye has low miscibility with the resin, making injection molding difficult.

Therefore, the mixing of the resin and the dye may be performed at a temperature at which the lens is injection-molded so that the dye may be adsorbed or dispersed between the polymer chains of the resin. Thus, the thermal decomposition properties of the dye have a heat resistance higher than the injection-molding temperature of the lens.

The UV-absorbing dye may be included in an amount of 0.002 to 0.1 wt % based on a total weight of the composition. If the content of the UV-absorbing dye is less than 0.002 wt %, light may not absorbed in the wavelength range in which light is to be absorbed, and if the content of the UV-absorbing dye exceeds 0.1 wt %, phase separation from the resin may occur or a portion of the visible light may be absorbed, which may cause a problem with the resolution.

In addition, the NIR-absorbing dye may be included in an amount of 0.002 to 0.1 wt % based on the total weight of the composition. If the content of the NIR-absorbing dye is less than 0.002 wt %, light may not be absorbed in the wavelength range in which light is to be absorbed, and if the content of the NIR-absorbing dye exceeds 0.1 wt %, phase separation from the resin may occur or a portion of the visible light may be absorbed, which may cause a problem with the resolution.

The resin is an optical resin and may be formed of a polycarbonate (PC) series or a polyolefin series.

The PC series resin has a chemical structure, as shown in Chemical Formula 1.

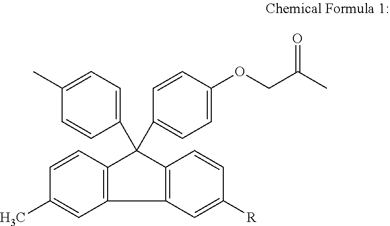

Also, the polyolefin series resin may be one of cyclo-olefin copolymer (COC) series resin and a cyclo-olefin polymer (COP) series resin, and has a refractive index of 1.54.

The COC series resin has a chemical structure as in Chemical Formula 2, and the COP series resin has a chemical structure as in Chemical Formula 3.

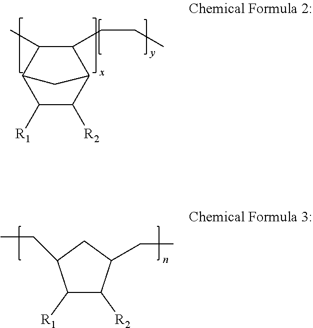

The composition for a camera module lens, according to a first embodiment in the present disclosure, includes a resin formed of COC.

The COC polymer has nonpolar properties, and the dye may also have a nonpolar chemical structure, so the dispersion properties may be improved when the dye is adsorbed or dispersed between the polymer chains of the resin.

Accordingly, the UV-absorbing dye may be a UV-absorbing dye of the methine series, and the NIR-absorbing dye may be a Squaraine series NIR-absorbing dye.

Referring to FIG. 4, the UV-absorbing dye of the methine series has a chemical structure of Chemical Formula 4, including a double bond structure of (R═C—H) connected to carbon so that an absorption wavelength in the UV region appears. Results of UV-VIS analysis show that the UV-absorbing dye of the methine series has an absorption range of 400 to 430 nm and has low light transmittance at a wavelength of 320 to 480 nm.

In the case of using the UV-absorbing dye of the methine series, the UV-absorbing dye of the methine series may be included in an amount of 0.002 to 0.1 wt % of the total weight of the composition for a lens. If the content of the UV-absorbing dye of the methine series is less than 0.002 wt %, the transmittance may increase, causing a problem in that the UV-absorbing effect is not properly implemented, and if the content of the UV-absorbing dye of the methine series exceeds 0.1 wt %, a portion of the visible light may be blocked, causing a deterioration in the optical properties of the lens.

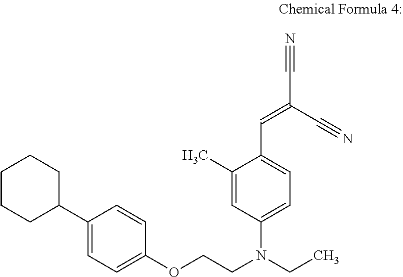 [SMILES: CCN(CCOc1ccc(C2CCCCC2)cc1)c1ccc(C=C(C#N)C#N)c(C)c1]

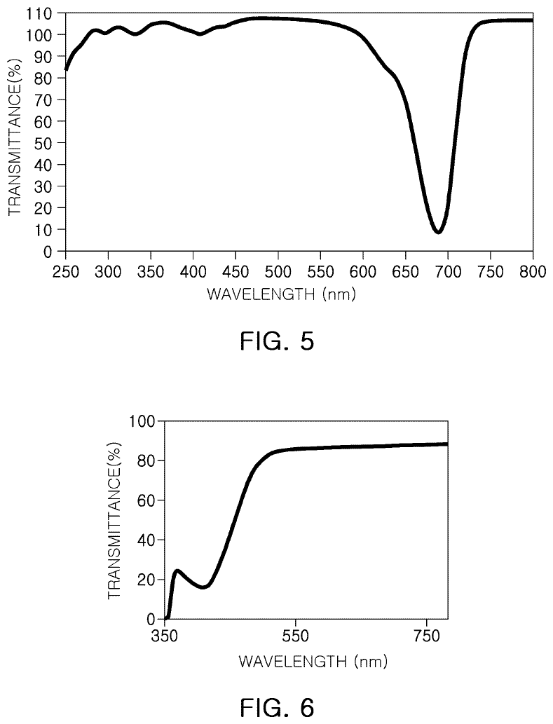

In the first embodiment, the NIR-absorbing dye of the squaraine series may be a first NIR-absorbing dye having a chemical structure of Chemical Formula 5 and a functional group of Chemical Formula 6. Referring to FIG. 5, results of UV-VIS analysis show that the first NIR-absorbing dye has an absorption wavelength of 700 nm.

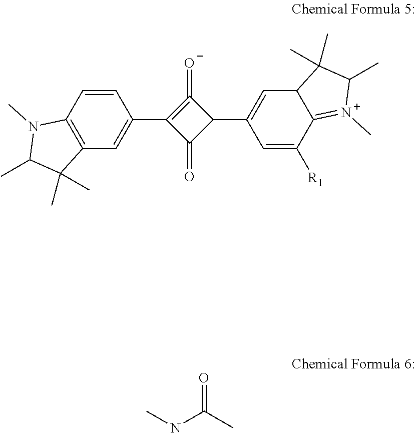

Also, the first NIR-absorbing dye may be included in an amount of 0.002 to 0.1 wt % of the total weight of the composition for a lens. If the content of the first NIR-absorbing dye is less than 0.002 wt %, transmittance may increase, which may cause a problem in that the effect of absorbing NIR at the wavelength in which light is to be absorbed may not be properly implemented, and if the content of the first NIR-absorbing dye exceeds 0.1 wt %, a portion of the visible light may be blocked, which may cause the optical properties of the lens to deteriorate.

According to a second embodiment in the present disclosure, a composition for a camera module lens includes a resin formed of COP or PC.

If the dye of the composition has low miscibility with the resin, it may be difficult to inject mold in the form of a lens. In addition, the polymer of the COP or PC series resin has a more polar characteristic than COC. Thus, in order to increase miscibility when the dye is adsorbed or dispersed between the polymer chains of the resin, the dye may also have a chemical structure with a more polar characteristic than that used in COC.

Accordingly, in the composition for a camera module lens of the second embodiment, the UV-absorbing dye may include any one or any combination of any two or more of pyrimidine, pyrazole, and UV-absorbing dye of the methine series.

The UV-absorbing dye of the pyrimidine, pyrazole, and methine series have good miscibility with the COP or PC series resin and do not reduce the transmittance in the visible light region.

In addition, the UV-absorbing dye may be included in an amount of 0.002 to 0.1 wt % of the total weight of the composition for a lens. Here, if the content of the UV-absorbing dye is less than 0.002 wt %, a problem may occur in which light is not absorbed in the wavelength range in which light is to be absorbed, and if the content of the UV-absorbing dye exceeds 0.1 wt %, phase separation may occur with the resin or a portion of the visible light may be absorbed, causing a problem in terms of resolution.

Referring to FIG. 6, the UV-absorbing dye of the pyrazole series has a chemical structure of Chemical Formula 7, and results of UV-VIS analysis show that the UV-absorbing dye of the pyrazole series has an absorption range of 400 to 430 nm and has low light transmittance at a wavelength of 320 to 480 nm.

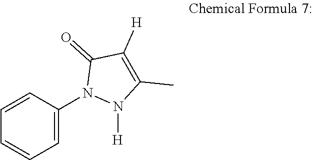

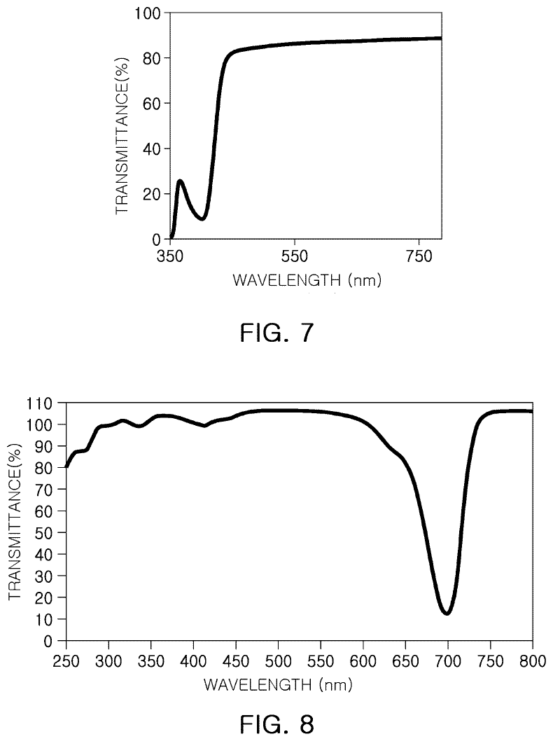

Referring to FIG. 7, the UV-absorbing dye of the pyrimidine series has a chemical structure of Chemical Formula 8, and results of UV-VIS analysis show that the UV-absorbing dye of the pyrimidine series has an absorption range of 400 to 430 nm and has low light transmittance at a wavelength of 320 to 480 nm.

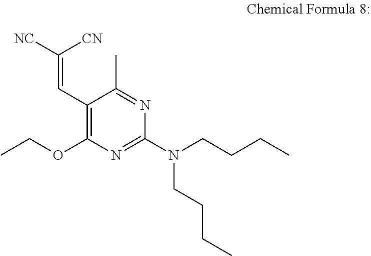 [SMILES: CCCCN(CCCC)c1nc(C)c(C=C(C#N)C#N)c(OCC)n1]

Also, the UV-absorbing dye of the methine series has the chemical structure of Chemical Formula 4, and the results of UV-VIS analysis show that the UV-absorbing dye of the methine series has an absorption range of 400 to 430 nm and has low light transmittance at a wavelength of 320 to 480 nm.

In the case of the resin of the COP or PC series, since the temperature during the injection-molding process is higher than that of COC resin, it may be desirable to suppress the thermal decomposition of the dye. To suppress thermal decomposition, the composition for a lens of the second embodiment uses a material having a high molecular weight as the NIR-absorbing dye.

Therefore, in the second embodiment, the NIR-absorbing dye may be a second NIR-absorbing dye of the squaraine series having a functional group of Chemical Formula 9 that is different from the first NIR-absorbing dye having the chemical structure of Chemical Formula 5.

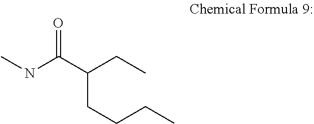

The molecular weight of the first NIR-absorbing dye used in the first embodiment is 542. When the resin is COC, the temperature of the injection-molding process is lower than that of the injection-molding process of COP or PC, so it is not significantly affected by the molecular weight of the NIR-absorbing dye. However, in the case of the composition for a lens of the second embodiment in which the resin is COP or PC, it is difficult to use the first NIR-absorbing dye due to the thermal decomposition issue.

A decomposition temperature increases according to the molecular weight; therefore, in the second embodiment, a dye with a molecular weight of 700 or more may be desirable to suppress thermal decomposition, and the second NIR-absorbing dye has a molecular weight of 710.

In addition, the results of UV-VIS analysis show that the second NIR-absorbing dye has an absorption wavelength of 700 nm.

In addition, the second NIR-absorbing dye may be included in an amount of 0.002 to 0.1 wt % of the total weight of the composition for a lens. If the content of the second NIR-absorbing dye is less than 0.002 wt %, the transmittance may increase, which may cause a problem in which the effect of absorbing NIR at the wavelength in which NIR is to be absorbed is not properly implemented. If the content of the second NIR-absorbing dye exceeds 0.1 wt %, a problem may occur in which a portion of the visible light is blocked, resulting in a deterioration of the optical properties of the lens.

### Camera Module Lens

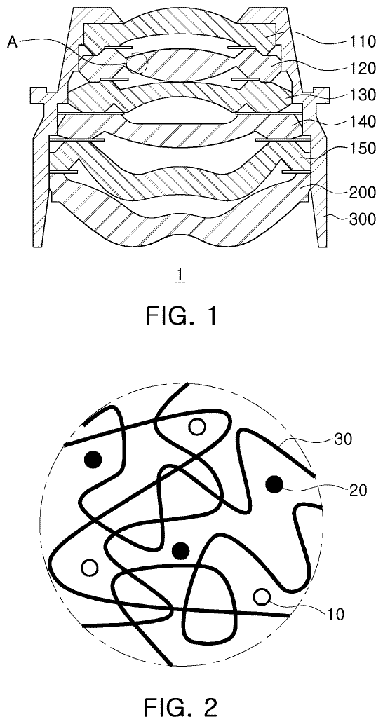

As illustrated in FIG. 1, the camera module 1 to which the lens of the present disclosure is applied includes a plurality of lenses 110, 120, 130, 140, 150, and 200, and a lens barrel 300 in which an accommodating space for accommodating the plurality of lenses 110, 120, 130, 140, 150, and 200 is formed.

The lens includes a resin, a UV-absorbing dye, and a NIR-absorbing dye, and the UV-absorbing dye and the NIR-absorbing dye are adsorbed or dispersed between the polymer chains of the resin.

The lens may function by cutting off the UV and NIR regions while transmitting a visible light region of 400 to 700 nm to replace the IR cut-filter of the related art camera module.

The lens is manufactured by compounding or injection-molding a composition prepared by adding a specific UV-absorbing dye and an NIR-absorbing dye to an optical resin, rather than surface coating or deposition.

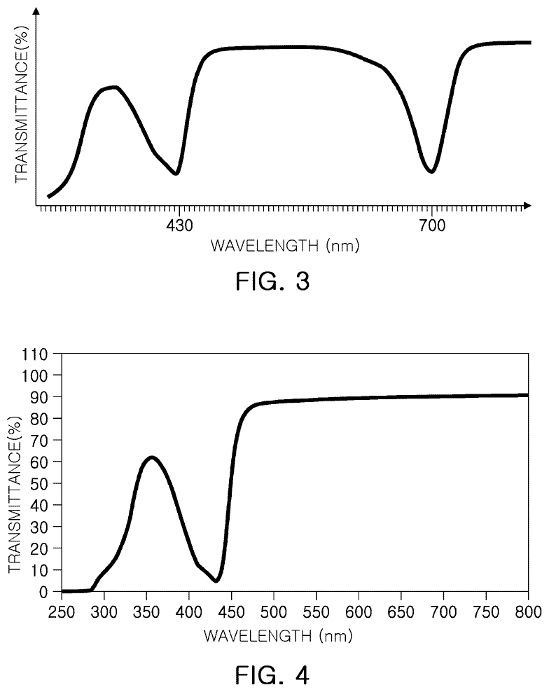

The lens, according to the present disclosure, is manufactured by adding a specific UV-absorbing dye and a NIR-absorbing dye to the resin and, as illustrated in FIG. 3, has a high visible light transmittance and has an absorption wavelength at UV 400 or 430 nm and an absorption wavelength at NIR 700 nm or higher.

Here, the lens is injection-molded at a high temperature, and as illustrated in FIG. 2, a UV-absorbing dye 10 and a NIR-absorbing dye 20 are absorbed or dispersed between the polymer chains 30, thereby improving the chromatic aberration and flare of the lens.

The related art camera module lens mainly uses COC series resins, and there are limitations on the dyes that may be used due to a problem that the dyes decompose during high-temperature injection-molding, resulting in UV blocking and NIR blocking effects that are not properly implemented.

However, the camera module lens, according to the present disclosure, may implement excellent transmittance characteristics while having excellent high-temperature stability by mixing the UV-absorbing dye and the NIR-absorbing dye with the resin and injection-molding the mixture in the form of a lens and may have improved chromatic aberration and flare, while having excellent optical characteristics, by cutting off light in the UV range and NIR range, while transmitting light in the visible light range of 400 to 700 nm or light in the visible light range of 430 to 700 nm.

The camera module lens configured as described above may be applied to product groups, such as smartphones, electric devices, and AR/VR, and the present disclosure is not limited thereto.

### Experimental Examples

The present disclosure is described in detail below through experimental examples, but this is to help specific understanding of the disclosure, and the experimental examples do not limit the scope of the present disclosure.

Here, a material included in the lens may be identified by obtaining an IR spectrum of the lens using the Fourier-transform infrared spectroscopy (FT-IR) transmission method and the infrared reflection absorption spectroscopy (IRRAS) method and analyzing a functional group of each chemical structure.

Alternatively, the components of the resin and dye in the lens may be identified through the mass using the thermogravimetric analysis combined with gas chromatography/mass spectrometry (TGA-GC/MS).

Through both of the methods, an approximate concentration of the components in the lens may be identified, and since a molar absorption coefficient is different for each material, UV-VIS analysis is additionally performed to identify the exact concentration.

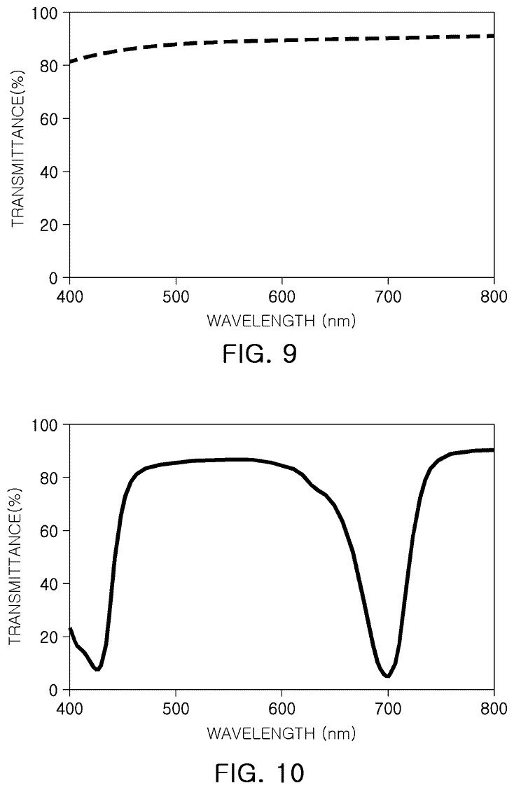

FIG. 9 is a graph illustrating light transmittance of a lens formed only of the related art COC resin. FIG. 10 is a graph illustrating light transmittance of a lens formed of a composition according to a first example in the present disclosure.

Here, in the lens of the first example, the resin was COC, and 0.002 wt % of a UV-absorbing dye of the methine series and 0.003 wt % of a first NIR-absorbing dye based on the total weight of the composition were included in the resin and injection-molded to manufacture the lens.

Referring to FIG. 9, it can be seen that the lens of a comparative example has no UV and NIR blocking effect at all.

As illustrated in FIG. 10, in the lens of the first example, a UV-absorbing dye of the methine series and a first NIR-absorbing dye of the squaraine series were included in the COC resin, and the UV-absorbing dye and the NIR-absorbing dye were adsorbed or dispersed between the polymer chains of the resin. It can be seen that visible light transmittance is sufficiently secured, and the UV and NIR regions are cut off.

Therefore, according to an embodiment in the present disclosure, the camera module lens having a UV and NIR blocking effect may be provided.

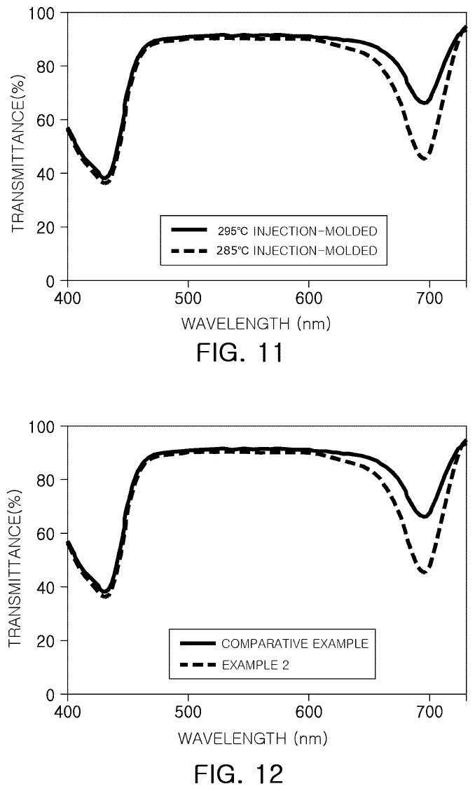

FIG. 11 is a graph illustrating a change in light transmittance according to an injection-molding temperature of a lens formed of a composition according to the first example of the present disclosure.

Here, injection-molding process temperatures of the COC resin were set to 285° C. and 295° C., and 0.002 wt % of the UV-absorbing dye of the methine series was included, and 0.003 wt % of the first NIR-absorbing dye was included based on the total weight of the composition according to the first embodiment.

Referring to FIG. 11, when the injection-molding process temperature of the resin is 285° C., light transmittance at 700 nm was 46%, and when the injection-molding process temperature of the resin increased by 10° C. to 295° C., the light transmittance at 700 nm increased to 66%.

That is, it can be seen that as the injection-molding process temperature of the resin increased, thermal decomposition of the dye occurred, and light transmittance of the lens in the NIR region increased. A desirable NIR transmittance in the camera module lens is 10 to 50% at 700 nm.

FIG. 12 is a graph illustrating a comparison between light transmittance of a lens formed of a composition according to a second example of the present disclosure and light transmittance of a lens of a comparative example each injection-molded at 300° C.

In the lens of the comparative example, the resin was COP, and 0.002 wt % of a UV-absorbing dye of the methine series and 0.003 wt % of the first NIR-absorbing dye as an NIR-absorbing dye were included.

In the lens of the second example, the resin was COP, 0.002 wt % of a UV-absorbing dye of the methine series and 0.003 wt % of a second NIR-absorbing dye, as a NIR-absorbing dye, were included.

Referring to FIG. 12, the light transmittance of the comparative example at 700 nm was 45%, and the light transmittance of the example was 12%.

The injection-molding process temperature of the COP resin was increased by about 10 to 15 compared to the COC. In the case of the comparative example, as the temperature increased, the thermal decomposition of the first NIR-absorbing dye occurred, thereby increasing the light transmittance, while in the case of the second example using the second NIR-absorbing dye with increased molecular weight, it can be seen that the light transmittance in the NIR region may be significantly reduced as the thermal decomposition is suppressed, compared to the comparative example.

Here, the UV absorption wavelengths of the comparative example and the second example were similar at about 26% at 430 nm.

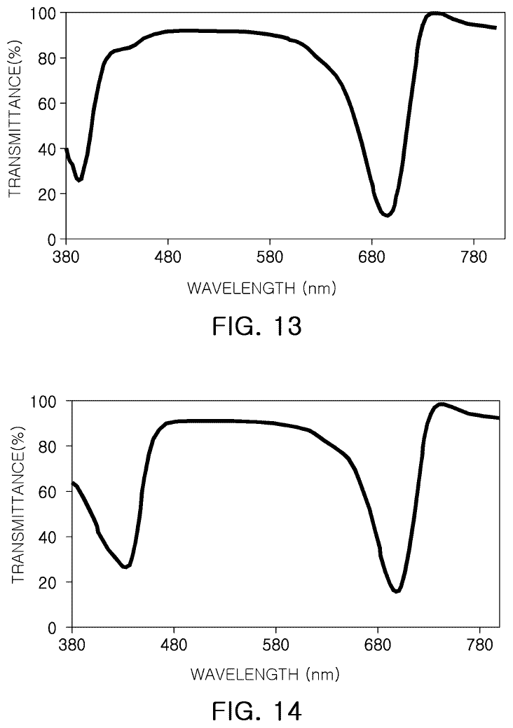

FIG. 13 and FIG. 14 are graphs illustrating comparisons in light transmittance of a lens according to a UV-absorbing dye in the second embodiment in the present disclosure.

In 2-1-th example of FIG. 13, the resin was COP, 0.003 wt % of the UV-absorbing dye of the methine series and 0.0023 wt % of the second NIR-absorbing dye, as the NIR-absorbing dye, were included.

In 2-2-th example of FIG. 14, the resin was COP, 0.005 wt % of the UV-absorbing dye of the pyrimidine series and 0.0023 wt % of the second NIR-absorbing dye, as the NIR-absorbing dye, were included.

Referring to FIGS. 13 and 14, the lens of the 2-1-th example had a UV absorption wavelength of 400 nm; in this case, the light transmittance was 26%. In addition, the lens of the 2-2-th example had a UV absorption wavelength of 430 nm; in this case, the light transmittance was 23%.

In this manner, by changing the material and content of the UV-absorbing dye, the absorption wavelength and transmittance may be varied depending on the product. The desirable UV transmittance in the camera module lens may be 20 to 60% at 400 to 430 nm, and more preferably less than 30%.

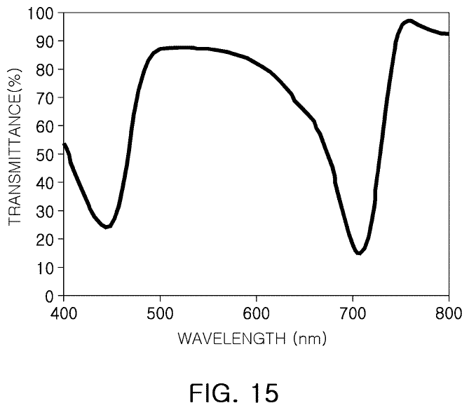

FIG. 15 illustrates light transmittance of a lens manufactured using PC as a resin in the second embodiment in the present disclosure.

Here, 0.003 wt % of the UV-absorbing dye of the methine series and 0.0023 wt % of the second NIR-absorbing dye, as the NIR-absorbing dye, were included.

Referring to FIG. 15, the UV absorption wavelength of the lens is 430 nm, and the light transmittance here is 26%. Therefore, it can be seen that it has an excellent UV-blocking effect and transmits visible light better compared to the case in which the resin is COP.

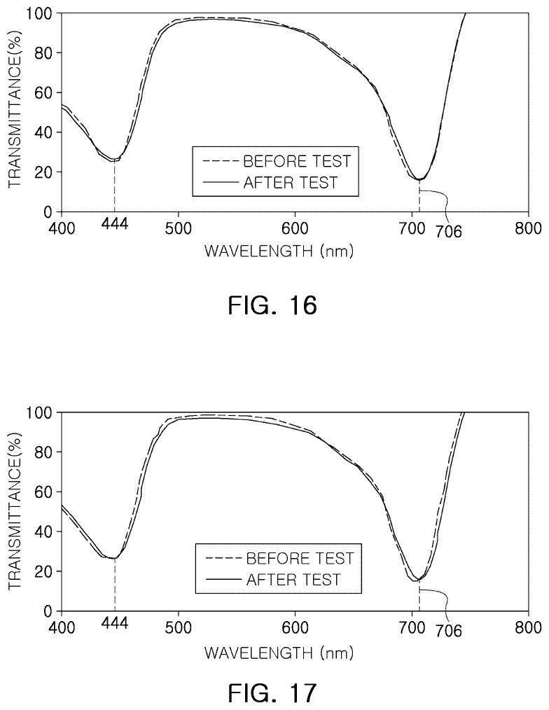

FIG. 16 is a graph illustrating results of a high-temperature and high-humidity reliability test of a lens according to an embodiment in the present disclosure. FIG. 17 is a graph illustrating results of a thermal shock reliability test of a lens according to an embodiment in the present disclosure.

The lens used in the test uses COC as a resin, includes 0.002 wt % of a UV-absorbing dye of the methine series as a UV-absorbing dye and 0.003 wt % of the first NIR-absorbing dye as a NIR-absorbing dye based on the total weight of the lens, and was manufactured by injection-molding.

The high-temperature and high-humidity reliability test was performed by placing the lens in an oven for 120 hours at a temperature of 85° C. and a humidity of 80% and measuring light transmittance of the lens before and after the test.

As illustrated in FIG. 16, in a low wavelength region, a change of −0.28 to 0.06% occurred after the test at 444 nm, which is a point indicating the lowest transmittance. In a high wavelength region, a change of −0.41 to −0.24% occurred after the test at 706 nm, which is a point indicating the lowest transmittance, so it can be seen that there was little change in the light transmittance of the lens before and after the test.

Therefore, it can be seen that the reliability of the lens manufactured through one or more embodiments in the present disclosure is excellent at high temperatures and high humidity.

The thermal shock reliability test was performed by repeating a process of leaving the lens at −40° C. for 30 minutes and then at 85° C. for 30 minutes 96 times and measuring the light transmittance of the lens before and after the test.

As illustrated in FIG. 17, in a low wavelength range, a change of 0.03 to 0.18% occurred after the test at 444 nm, and in a high wavelength region, a change of −0.13 to 0.09% occurred after the test at 706 nm, confirming that there was little change in the light transmittance of the lens before and after the test.

Therefore, it can be seen that the thermal shock reliability of the lens manufactured through an embodiment in the present disclosure is excellent.

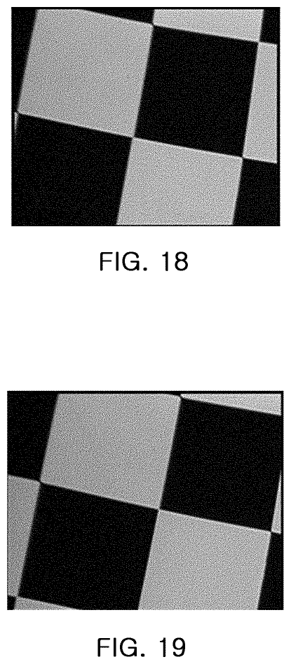

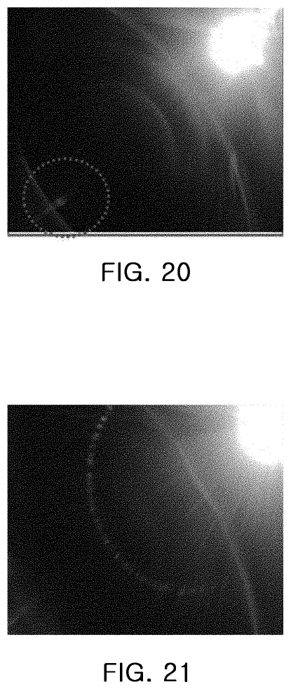

FIGS. 18 and 19 are photographs illustrating chromatic aberrations of the related art lens (comparative example) and a lens (example) manufactured by an embodiment in the present disclosure. FIGS. 20 and 21 are photographs for comparing the flare of the related art lens and a lens manufactured by an embodiment in the present disclosure.

The related art lens was manufactured as a 100% COC lens, and the lens of an embodiment was manufactured using COC as a resin and including 0.002 wt % of a UV-absorbing dye of the methine series as a UV-absorbing dye and 0.003 wt % of a first NIR-absorbing dye of the squaraine series as a NIR-absorbing dye based on the total weight of the lens.

Chromatic aberration is a phenomenon in which colors appear around an image with uneven deflection of light of various wavelengths passing through a refractive medium.

Referring to FIGS. 18 and 19, the chromatic aberration value of the comparative example is 0.95, and the chromatic aberration value of the example is 0.63, confirming that the chromatic aberration of the example is significantly lower than that of the comparative example.

In addition, referring to FIGS. 20 and 21, it can be seen that a ghost phenomenon of the lens of the example is improved compared to the lens of the comparative example, thereby confirming that the lens of the example has reduced flare compared to the lens of the comparative example.

Therefore, according to an embodiment in the present disclosure, the camera module lens having significantly improved chromatic aberration and flare compared to the related art lens may be provided.

According to one or more embodiments in the present disclosure, light in the visible light region is transmitted, while light in the UV region and the NIR region is cut off, thereby improving chromatic aberration and flare of the lens, while having excellent optical characteristics.

One or more embodiments of the present disclosure provide a composition for a camera module lens and a camera module lens including the same, capable of replacing the role of the related art IR filter by cutting off an ultraviolet (UV) region and a near-infrared ray (NIR) region, while improving chromatic aberration and flare.

In addition, the composition for a camera module lens may be utilized in a camera module lens of a product, such as a smartphone, an electric device, or AR/VR by replacing the IR cut-filter of the related art camera module lens.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A composition for a camera module lens, the composition comprising:
a resin;
an ultraviolet (UV) absorbing dye; and
a near infrared ray (NIR) absorbing dye,
wherein the UV-absorbing dye and the NIR-absorbing dye are adsorbed or dispersed between polymer chains of the resin.

2. The composition of claim 1, wherein the UV-absorbing dye comprises an amount of 0.002 to 0.1 wt % based on a total weight of the composition.

3. The composition of claim 1, wherein the NIR-absorbing dye comprises an amount of 0.002 to 0.1 wt % based on a total weight of the composition.

4. The composition of claim 1, wherein
the resin is cyclo-olefin copolymer (COC),
the UV-absorbing dye is a methine series, and
the NIR-absorbing dye is a squaraine series.

5. The composition of claim 4, wherein the composition comprises 0.002 to 0.1 wt % of a UV-absorbing dye of the methine series and 0.002 to 0.1 wt % of a NIR-absorbing dye of the squaraine series based on a total weight of the composition,
wherein the composition has an absorption range of 400 to 430 nm and another absorption range of 700 nm or more, and
wherein the composition has a light transmittance of 20 to 60% at 400 to 430 nm and a light transmittance of 10 to 50% at 700 nm.

6. The composition of claim 1, wherein
the resin is cyclo-olefin polymer (COP),
the UV-absorbing dye is any one or any combination of any two or more of pyrimidine, pyrazole and methine series, and
the NIR-absorbing dye is a squaraine series.

7. The composition of claim 6, wherein the composition comprises 0.002 to 0.1 wt % of a UV-absorbing dye of any one or any combination of any two or more of pyrimidine, pyrazole and methine series, and 0.002 to 0.1 wt % of a NIR-absorbing dye of squaraine series based on a total weight of the composition,
wherein the composition has an absorption range of 400 to 430 nm and another absorption range of 700 nm or more, and
wherein the composition has a light transmittance of 20 to 60% at 400 to 430 nm and a light transmittance of 10 to 50% at 700 nm.

8. The composition of claim 6, wherein the NIR-absorbing dye has a molecular weight of 700 or more.

9. The composition of claim 8, wherein
the NIR-absorbing dye is a squaraine series having a chemical structure of:

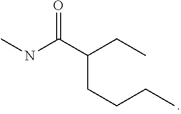

10. The composition of claim 1, wherein
the resin is polycarbonate (PC),
the UV-absorbing dye is any one or any combination of any two or more of the pyrimidine, pyrazole and methine series, and
the NIR-absorbing dye is the squaraine series.

11. The composition of claim 10, wherein the composition comprises 0.002 to 0.1 wt % of a UV-absorbing dye of any one or any combination of any two or more of pyrimidine, pyrazole and methine series, and 0.002 to 0.1 wt % of a NIR-absorbing dye of squaraine series based on a total weight of the composition,
wherein the composition has an absorption range of 400 to 430 nm and another absorption range of 700 nm or more, and
wherein the composition has a light transmittance of 20 to 60% at 400 to 430 nm and a light transmittance of 10 to 50% at 700 nm.

12. The composition of claim 10, wherein the NIR-absorbing dye has a molecular weight of 700 or more.

13. The composition of claim 12, wherein
the NIR-absorbing dye is a squaraine series having a chemical structure of:

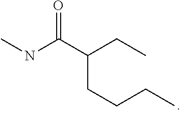

14. A camera module lens, comprising:
a plurality of lenses, wherein one or more lenses of the plurality of lenses comprise the composition of claim 1.
